(19) United States
(12) Patent Application Publication
(10) Pub. No.: US 2015/0022308 A1
(43) Pub. Date: Jan. 22, 2015

(54) MAGNETIC MATERIAL, METHOD FOR MANUFACTURING THE SAME, AND ELECTRONIC COMPONENT INCLUDING THE SAME

(71) Applicant: SAMSUNG ELECTRO-MECHANICS CO., LTD., Suwon (KR)

(72) Inventors: Byeong Cheol MOON, Suwon (KR); Il Jin PARK, Suwon (KR); Myeong Gi KIM, Suwon (KR); Jin Woo HAN, Suwon (KR)

(73) Assignee: SAMSUNG ELECTRO-MECHANICS CO., LTD., Suwon (KR)

(21) Appl. No.: 14/059,047

(22) Filed: Oct. 21, 2013

(30) Foreign Application Priority Data
Jul. 22, 2013 (KR) 10-2013-0086105

(51) Int. Cl. H01F 1/01; H01F 27/255

(52) U.S. Cl. CPC H01F 1/01; H01F 27/255
USPC 336/221; 252/62.56

(57) ABSTRACT

There is provided a magnetic material including a plurality of composite magnetic particles including oxide layers formed on surfaces thereof, and a ferrite present between the plurality of composite magnetic particles.

### CROSS-REFERENCE TO RELATED APPLICATIONS

This application claims the priority of Korean Patent Application No. 10-2013-0086105 filed on Jul. 22, 2013, in the Korean Intellectual Property Office, the disclosure of which is incorporated herein by reference.

### BACKGROUND OF THE INVENTION

1. Field of the Invention

The present invention relates to a magnetic material, a method for manufacturing the same, and an electronic component including the same.

2. Description of the Related Art

Electronic components using a ceramic material may include a capacitor, an inductor, a piezoelectric element, a varistor, a thermistor and the like.

Among these ceramic electronic components, an inductor may be a main passive element configuring an electronic circuit, together with a resistor and a capacitor, and may be generally used as a component removing noise or constituting an LC resonance circuit.

An inductor may be manufactured by winding or printing a coil on a ferrite core and then forming electrodes on both ends thereof, or may be manufactured by printing internal electrodes on a magnetic material or a dielectric material and then stacking the internal electrodes.

Inductors may be classified into several types of inductors such as a laminated type inductor, a winding type inductor, a thin-film type inductor, and the like, according to structures thereof. The respective inductors may be different in view of a manufacturing method as well as a range of the application thereof.

Among these inductors, the winding type inductor may be formed by winding a coil around a ferrite core, for example, and in a case in which the number of turns of the coil is increased in order to obtain a high degree of inductance, stray capacitance between coil portions, that is, capacitance between wires, may be generated to deteriorate high frequency characteristics of a product.

In addition, the laminated type inductor may be manufactured in the form of a laminate in which a plurality of ceramic sheets formed of a ferrite or low k-dielectric are stacked.

In this case, metal patterns having coil shapes may be formed on the respective ceramic sheets, and the metal patterns having coil shapes formed on the respective ceramic sheets may be sequentially connected through conductive vias formed in the respective ceramic sheets, and may be overlapped with one another in a vertical direction in which the sheets are stacked.

According to the related art, an inductor body constituting the laminated type inductor may be generally formed using a ferrite material including 4 elements of nickel (Ni)-zinc (Zn)-copper (Cu)-iron (Fe).

However, since the ferrite material has a saturation magnetization value lower than that of a metallic material, high current properties required for recent electronic products may not be implemented.

Therefore, in a case in which the inductor body constituting the laminated type inductor is formed by using a metallic component, the inductor body may have a saturation magnetization value relatively increased as compared to that of the above-mentioned inductor body formed of ferrite. However, in this case, an eddy current loss may be increased in high frequencies, such that a material loss may be increased.

In order to decrease the material loss, metal powder particles are insulated from each other, using a polymer resin applied therebetween, in the related art. However, in this case, a volume fraction of the metal is deteriorated, such that permeability may be decreased.

Patent Document 1 discloses a magnetic material; however, Patent Document 1 fails to disclose a structure in which a ferrite is provided between metal powder particles.

### RELATED ART DOCUMENT

(Patent Document 1) Japanese Patent Laid-Open Publication No. JP 2012-238840

### SUMMARY OF THE INVENTION

An aspect of the present invention provides a magnetic material, a method for manufacturing the same, and an electronic component including the same.

According to an aspect of the present invention, there is provided a magnetic material including: a plurality of composite magnetic particles including oxide layers formed on surfaces thereof; and a ferrite present between the plurality of composite magnetic particles.

The oxide layers may include chromium oxide (Cr₂O₃).

The composite magnetic particles may include an iron (Fe)-based metal.

The composite magnetic particles may include chromium (Cr).

The composite magnetic particles may include an iron (Fe)-based metal containing chromium (Cr).

According to another aspect of the present invention, there is provided a method for manufacturing a magnetic material, the method including: preparing first magnetic powder particles; preparing second magnetic powder particles having an average particle size smaller than that of the first magnetic powder particles; preparing additive powder particles having an average particle size smaller than that of the first magnetic powder particles; preparing mixed powder particles by mixing the first magnetic powder particles, the second magnetic powder particles, and the additive powder particles; and heat-treating the mixed powder particles to form a plurality of composite magnetic particles including oxide layers formed on surfaces thereof and a ferrite present between the plurality of composite magnetic particles.

The first magnetic powder particles may include an iron (Fe)-based metal.

The first magnetic powder particles may include an iron (Fe)-based metal containing chromium (Cr).

The second magnetic powder particles may include an iron (Fe)-based metal.

The second magnetic powder particles may include pure iron.

The average particle size of the second magnetic powder particles may be equal to or smaller than ½ of the average particle size of the first magnetic powder particles.

The average particle size of the second magnetic powder particles may be smaller than 5 μm.

The average particle size of the additive powder particles may be smaller than that of the second magnetic powder particles.

The average particle size of the additive powder particles may be smaller than 1 μm.

The additive powder particles may include at least one of a metal capable of forming the ferrite through a reaction with iron oxide and oxides thereof.

The additive powder particles may include at least one of nickel (Ni), zinc (Zn), copper (Cu), and oxides thereof.

The heat-treating of the mixed powder particles may include firing the mixed powder particles under an atmosphere containing oxygen.

The composite magnetic particles may be formed by heat-treating the first magnetic powders.

The first magnetic powder particles may include chromium (Cr), and the oxide layers may include chromium oxide (Cr₂O₃) formed by oxidizing chromium (Cr) included in the first magnetic powder particles through the heat-treating under an atmosphere containing oxygen.

The ferrite may be formed from an oxide of the second magnetic powder particles formed by oxidizing the second magnetic powder particles and an oxide of the additive powder particles formed by oxidizing the additive powder particles through the heat-treating under an atmosphere containing oxygen, or may be formed from the oxide of the second magnetic powder particles and the additive powder particles.

According to another aspect of the present invention, there is provided an electronic component including: a body part including a magnetic material; a coil part formed in the body part; and external electrodes electrically connected to the coil part, wherein the magnetic material includes a plurality of composite magnetic particles including oxide layers formed on surfaces thereof; and a ferrite present between the plurality of composite magnetic particles.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing a method for manufacturing a magnetic material according to an embodiment of the present invention and the magnetic material manufactured by the method;

FIG. 2 is a flow chart showing the method for manufacturing the magnetic material according to the embodiment of the present invention;

FIG. 3 is a perspective view schematically showing an electronic component according to an embodiment of the present invention;

FIG. 4 is an exploded perspective view of a body of the electronic component according to the embodiment of the present invention; and

FIG. 5 is a cross sectional view of the electronic component according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

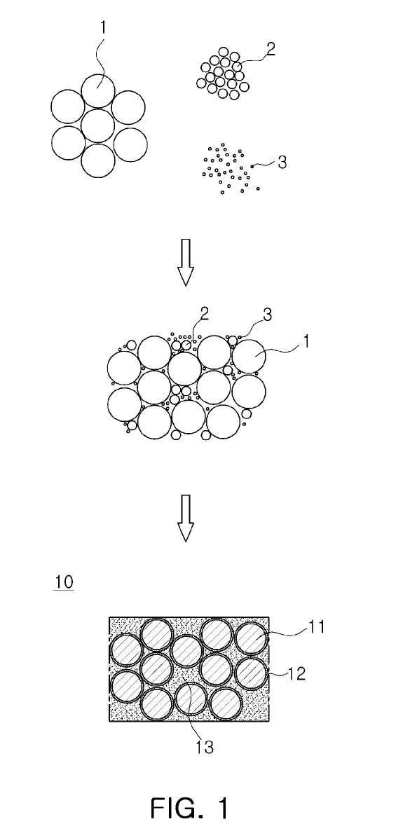

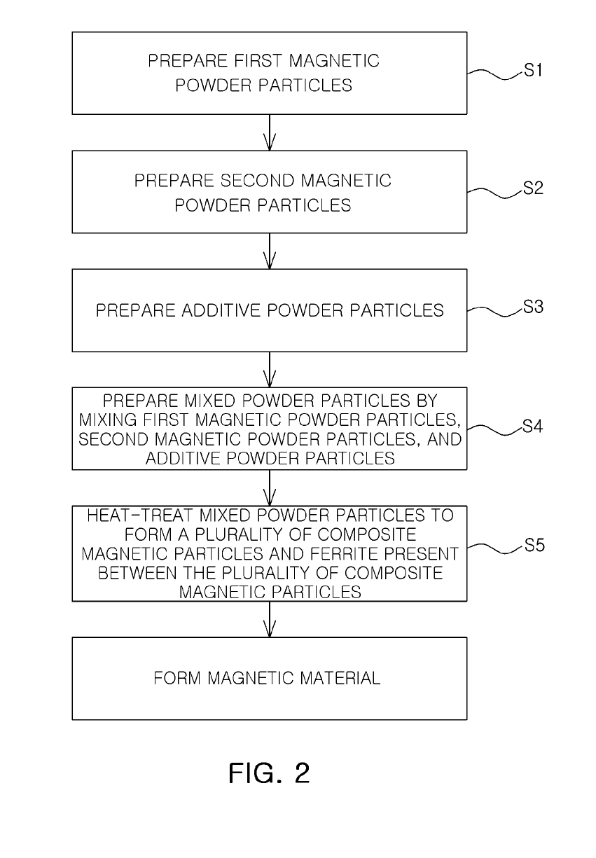

FIG. 1 is a view schematically illustrating a method for manufacturing a magnetic material according to an embodiment of the present invention and the magnetic material manufactured by the method. FIG. 2 is a flowchart illustrating the method for manufacturing the magnetic material according to the embodiment of the present invention.

Referring to FIGS. 1 and 2, a magnetic material 10 according to the embodiment of the present invention may be manufactured by the manufacturing method including: preparing first magnetic powder particles 1 (S1); preparing second magnetic powder particles 2 having an average particle size smaller than that of the first magnetic powder particles 1 (S2); preparing additive powder particles 3 having an average particle size smaller than that of the first magnetic powder particles 1 (S3); preparing mixed powder particles by mixing the first magnetic powder particles 1, the second magnetic powder particles 2, and the additive powder particles 3 (S4); and heat-treating the mixed powder particles to form a plurality of composite magnetic particles 11 including oxide layers 12 formed on surfaces thereof and a ferrite 13 present between the plurality of composite magnetic particles 11 (S5).

The first magnetic powder particles 1 may include an iron (Fe)-based metal, and the iron (Fe)-based metal may contain a metal having a degree of reactivity higher than that of iron. That is, the first magnetic powder particles may include an iron (Fe)-based metal containing chromium (Cr).

The second magnetic powder particles 2 may include an iron (Fe)-based metal, and the iron (Fe)-based metal contained in the second magnetic powder particles may be pure iron. In the strict sense, pure iron indicates iron not containing impurities at all, but having 100% purity. However, since it may be difficult to completely remove impurities such as carbon, nitrogen, silicon, phosphorus, sulfur, and the like from iron, pure iron generally refers to iron having a level of purity higher than those of most other irons, and in the present invention, the term ‘pure iron’ is used in the sense of having a general meaning.

The additive powder particles 3 may include at least one of a metal capable of forming a ferrite through a reaction with iron oxide and oxides thereof, and for example, at least one of nickel (Ni), zinc (Zn), copper (Cu), and oxides thereof, but the present invention is not limited thereto.

The first magnetic powder particles may have an average particle size larger than those of the second magnetic powder particles and the additive powder particles. In particular, the average particle size of the second magnetic powder particles may be equal to or smaller than ½ of the average particle size of the first magnetic powder particles.

In addition, the average particle size of the additive powder particles may be smaller than that of the second magnetic powder particles.

The average particle size of the first magnetic powder particles may be 5 μm or larger, the average particle size of the second magnetic powder particles may be less than 5 μm, and the average particle size of the additive powder particles may be less than 1 μm, but the present invention is not limited thereto.

The first magnetic powder particles, the second magnetic powder particles, and the additive powder particles may be mixed to prepare the mixed powder particles.

Here, the average particle size of the second magnetic powder particles and the average particle size of the additive powder particles may be formed to be smaller than that of the first magnetic powder particles, whereby the second magnetic powder particles and the additive powder particles may be disposed in gaps between the first magnetic powder particles. The average particle size of the additive powder particles is smaller than that of the second magnetic powder particles, whereby the additive powder particles may be disposed in the gaps between the first magnetic powder particles and the second magnetic powder particles to thereby improve a density of the mixed powder particles.

Then, the mixed powder particles may be heat-treated to form a magnetic material according to the embodiment of the present invention. The heat-treating may include firing the mixed powder particles under an atmosphere containing oxygen, and may be performed by applying a predetermined level of pressure to the mixed powder particles. When the mixed powder particles are fired under the atmosphere containing oxygen, in the first magnetic powder particles including the iron (Fe)-based metal containing the metal having a degree of reactivity higher than that of iron, the metal having higher reactivity may be firstly oxidized, such that the composite magnetic particles 11 having oxide layers 12 formed on surfaces thereof may be formed. The oxide layers may protect the metal present in the first magnetic powder particles to prevent an oxidation of the metal. In the case in which the first magnetic powder particles include the iron (Fe)-based metal containing chromium (Cr), the composite magnetic particles may be formed while the oxide layers including chromium oxide (Cr₂O₃) are formed on surfaces of the first magnetic powder particles.

In addition, since the second magnetic powder particles do not include a separate metal having a high degree of reactivity, the second magnetic powder particles may be oxidized under the atmosphere containing oxygen. In particular, when the second magnetic powder particles include pure iron, even in a case in which a general level of pressure (about 100 MPa or less) in a firing process is applied in the heat-treating process, a filling density of the mixed powder particles may be significantly improved due to the ductility of the pure iron. The second magnetic powder particles may include an iron (Fe)-based metal, and the iron (Fe)-based metal may be oxidized under the atmosphere containing oxygen to be changed into iron oxide (Fe₂O₃).

The additive powder particles may include at least one of a metal capable of forming a ferrite through a reaction with iron oxide and oxides thereof, and in the case in which the additive powder particles include the metal, the additive powder particles may be oxidized under the atmosphere in which the second magnetic powder particles are oxidized to form an oxide phase of the additive powder particles.

For example, in the case in which the additive powder particles include nickel (Ni), the additive powder particles may be changed into nickel oxides (NiO) in the heat-treating process.

Further, the ferrite may be formed by reacting the oxide of the second magnetic powder particle and the oxide of the additive powder particle (in a case in which the additive powder particle initially includes an oxide of the metal, the additive powder particle may serve as the oxide thereof) at a high temperature by the heat-treating process.

For example, in the case in which the second magnetic powder particles include pure iron and the additive powder particles include nickel, iron oxide (Fe₂O₃) formed by oxidizing the pure iron and nickel oxide (NiO) formed by oxidizing the nickel may be reacted with each other to form a nickel-ferrite.

The ferrite may be present between the plurality of composite magnetic particles formed from the first magnetic powder particles, and in the case of controlling contents of the first magnetic powder particles, the second magnetic powder particles, and the additive powder particles, the ferrite may cover the composite magnetic particles.

That is, the magnetic material including the plurality of magnetic particles including the oxide layers formed on the surfaces thereof; and the ferrite present between the plurality of magnetic particles may be obtained by the above-described processes.

The magnetic material according to the embodiment of the present invention may have a high saturation magnetization value due to the non-oxidization of the magnetic metal present in the composite magnetic particle, and the oxide layer may be formed on the surface of the composite magnetic particle to efficiently insulate the magnetic metal that has not been oxidized from the surface of the composite magnetic particle, such that eddy current loss and hysteresis loss may be decreased.

The ferrite present between the composite magnetic particles may serve as an insulator between the composite magnetic particles, such that the eddy current loss and the hysteresis loss may be significantly decreased. In addition, a volume fraction of the magnetic material present in the magnetic material is increased due to the ferrite, such that permeability of the material may be increased. Patent Document 1 discloses a magnetic material in which gaps between magnetic particles having oxide films formed thereon are filled with a polymer material. However, in the present invention, the gaps between the composite magnetic particles are filled with the ferrite to realize insulation, such that the saturation magnetization value of the magnetic material may be improved.

In particular, in the case in which the previously formed ferrite and the magnetic particles are mixed to form the magnetic material, a bonding agent such as a polymer is included in the magnetic material in order to bond the ferrite and the magnetic particles to deteriorate the saturation magnetization value. However, according to the embodiment of the present invention, the ferrite may be formed through the reaction of powder particles for forming the ferrite during the firing process, such that the ferrite may serve as the bonding agent.

In addition, in a process in which the second magnetic powder particles and the additive powder particles are changed into the ferrite, since the volume thereof is increased, the gaps between the composite magnetic particles may be further efficiently filled with the ferrite, such that the density of the magnetic material may be improved.

Further, the magnetic material according to the embodiment of the present invention may be formed by mixing powder particles having different particle sizes and may include fine additive powder particles to improve surface roughness properties of the magnetic material.

In the following embodiment of the present invention, an electronic component including the ferrite according to the embodiment of the present invention is exemplified as a laminated type inductor device, but the present invention is not limited thereto.

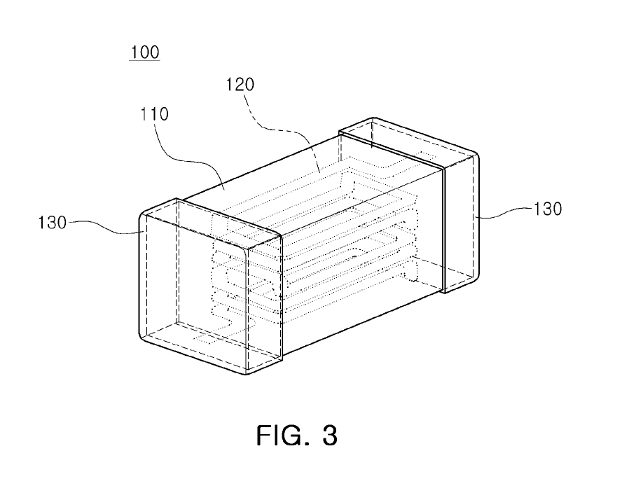

FIG. 3 is a perspective view schematically showing an electronic component according to an embodiment of the present invention.

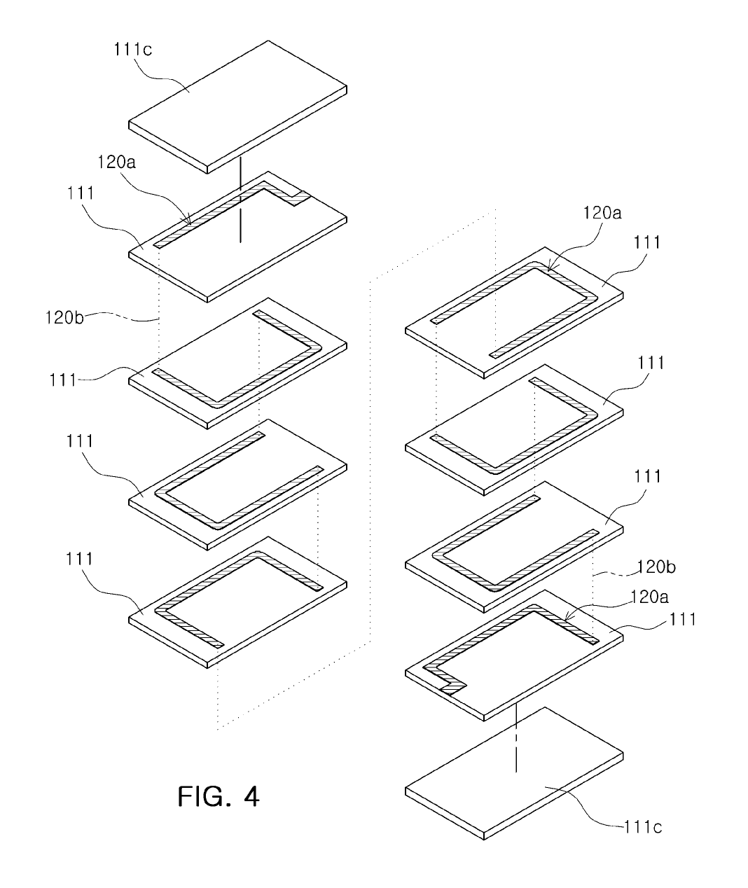

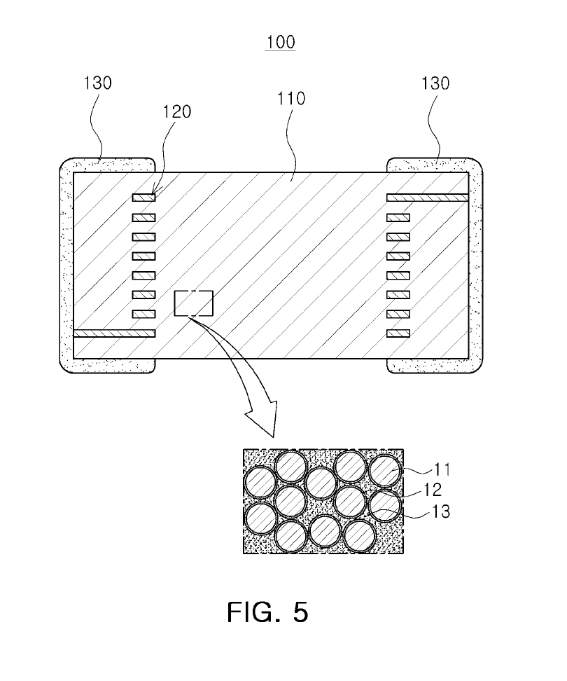

FIG. 4 is an exploded perspective view of a body of the electronic component according to the embodiment of the present invention. FIG. 5 is a cross sectional view of the electronic component according to the embodiment of the present invention.

Referring to FIGS. 3 to 5, a laminated type inductor 100 according to the embodiment of the present invention may include a body part 110, a coil part 120, and external electrodes 130.

The body part 110 may be formed by stacking a plurality of magnetic layers 111 in a thickness direction and the performing firing thereon, and a shape and a size of the body part 110 and the number of stacked magnetic layers 111 are not limited to being illustrated in the present embodiment.

The body part 110 is not specifically limited in view of a shape, and for example, may have a hexahedral shape. In the present embodiment, for convenience of explanation, surfaces of the body part 110 facing each other in a thickness direction are defined as upper and lower surfaces, surfaces connecting the upper and lower surfaces and facing each other in a length direction are defined as both end surfaces, and surfaces vertically intersecting both end surfaces and facing each other in a width direction are defined as both side surfaces.

The magnetic layers may include the magnetic material according to the embodiment of the present invention, and a description overlapping with the above-described descriptions will be omitted in order to avoid a repeated description.

The plurality of magnetic layers may have conductive patterns 120a formed on one surfaces thereof to form the coil part 120 and may have conductive vias 120b formed in a thickness direction to penetrate therethrough, the conductive vias 120c electrically connecting the conductive patterns in a vertical direction.

Therefore, respective one ends of the conductor patterns formed on the respective magnetic layers may be electrically connected to one another through the conductive vias formed in the adjacent magnetic layers, such that the coil part 120 may be formed.

The coil part may include at least one conductive metal of silver (Ag), palladium (Pd), platinum (Pt), nickel (Ni), and copper (Cu), or alloys thereof, and the like, but the present invention is not limited thereto.

Both ends of the coil part 120 may be exposed to the outside through the body part 110 and may contact to a pair of the external electrodes 130 formed in the body part 110 to be electrically connected to the external electrodes 130, respectively.

In particular, both ends of the coil part 120 may be exposed through both ends of the body part 110, and the pair of external electrodes 130 may be formed on both ends of the body part 110 to which the coil part 120 is exposed.

At least one cover layer 111c may be formed on each of the upper and lower surfaces of the body part 110. The cover layer 111c may have the same material and the same construction as those of the magnetic layers 111 except that the conductive patterns of the coil part are not included therein. The cover layer 111c may basically prevent the coil part 120 from being damaged by physical or chemical stress.

The external electrodes 130 may contact both ends of the coil part 120 exposed through the body part 110 to be electrically connected thereto, respectively. The external electrodes 130 may be formed on the body part 110 by dipping the body part 110 in a conductive paste, or by performing various methods such as a printing method, a deposition method, and a sputtering method.

The conductive paste may be formed of a material including one of silver (Ag), copper (Cu), and a copper (Cu) alloy, but the present invention is not limited thereto.

In addition, outer surfaces of the external electrodes 20 may be provided with a nickel (Ni) plating layer (not shown) and a tin (Sn) plating layer (not shown), if necessary.

As set forth above, according to the embodiment of the present invention, a magnetic material having a high saturation magnetization value, low eddy current loss, and low hysteresis loss, a method for manufacturing the same, and an electronic component including the same may be provided.

While the present invention has been shown and described in connection with the embodiments, it will be apparent to those skilled in the art that modifications and variations can be made without departing from the spirit and scope of the invention as defined by the appended claims.

What is claimed is:

1. A magnetic material comprising:
a plurality of composite magnetic particles including oxide layers formed on surfaces thereof; and
a ferrite present between the plurality of composite magnetic particles.

2. The magnetic material of claim 1, wherein the oxide layers include chromium oxide (Cr₂O₃).

3. The magnetic material of claim 1, wherein the composite magnetic particles include an iron (Fe)-based metal.

4. The magnetic material of claim 1, wherein the composite magnetic particles include chromium (Cr).

5. The magnetic material of claim 1, wherein the composite magnetic particles include an iron (Fe)-based metal containing chromium (Cr).

6. A method for manufacturing a magnetic material, the method comprising:
preparing first magnetic powder particles;
preparing second magnetic powder particles having an average particle size smaller than that of the first magnetic powder particles;
preparing additive powder particles having an average particle size smaller than that of the first magnetic powder particles;
preparing mixed powder particles by mixing the first magnetic powder particles, the second magnetic powder particles, and the additive powder particles; and
heat-treating the mixed powder particles to form a plurality of composite magnetic particles including oxide layers formed on surfaces thereof and a ferrite present between the plurality of composite magnetic particles.

7. The method of claim 6, wherein the first magnetic powder particles include an iron (Fe)-based metal.

8. The method of claim 6, wherein the first magnetic powder particles include an iron (Fe)-based metal containing chromium (Cr).

9. The method of claim 6, wherein the second magnetic powder particles include an iron (Fe)-based metal.

10. The method of claim 6, wherein the second magnetic powder particles include pure iron.

11. The method of claim 6, wherein the average particle size of the second magnetic powder particles is equal to or smaller than ½ of the average particle size of the first magnetic powder particles.

12. The method of claim 6, wherein the average particle size of the second magnetic powder particles is smaller than 5 μm.

13. The method of claim 6, wherein the average particle size of the additive powder particles is smaller than that of the second magnetic powder particles.

14. The method of claim 6, wherein the average particle size of the additive powder particles is smaller than 1 μm.

15. The method of claim 6, wherein the additive powder particles include at least one of a metal capable of forming the ferrite through a reaction with iron oxide and oxides thereof.

16. The method of claim 6, wherein the additive powder particles include at least one of nickel (Ni), zinc (Zn), copper (Cu), and oxides thereof.

17. The method of claim 6, wherein the heat-treating of the mixed powder particles includes firing the mixed powder particles under an atmosphere containing oxygen.

18. The method of claim 6, wherein the composite magnetic particles are formed by heat-treating the first magnetic powder particles.

19. The method of claim 6, wherein the first magnetic powder particles include chromium (Cr), and the oxide layers include chromium oxide (Cr₂O₃) formed by oxidizing chromium (Cr) included in the first magnetic powder particles through the heat-treating under an atmosphere containing oxygen.

20. The method of claim 6, wherein the ferrite is formed from an oxide of the second magnetic powder particles formed by oxidizing the second magnetic powder particles and an oxide of the additive powder particles formed by oxidizing the additive powder particles through the heat-treating under an atmosphere containing oxygen, or is formed from the oxide of the second magnetic powder particles and the additive powder particles.

21. An electronic component comprising:
a body part including a magnetic material;
a coil part formed in the body part; and
external electrodes electrically connected to the coil part,
wherein the magnetic material includes a plurality of composite magnetic particles including oxide layers formed on surfaces thereof; and a ferrite present between the plurality of composite magnetic particles.
